(19) United States
(12) Patent Application Publication
(10) Pub. No.: US 2004/0003090 A1
(43) Pub. Date: Jan. 1, 2004

(54) Peer-to-peer media sharing

(76) Inventor: Douglas Deeds, Fort Worth, TX (US)

Correspondence Address: SCHEEF & STONE, L.L.P., 5956 SHERRY LANE, SUITE 1400, DALLAS, TX, 75225, US

(21) Appl. No.: 10/185,398

(22) Filed: Jun. 28, 2002

(51) Int. Cl. G06F 15/16

(52) U.S. Cl. 709/227; 709/204

(57) ABSTRACT

A system and method for peer-to-peer media sharing through a network such as the Internet. The shared media will often be audio media, but could include other types as well. A server, for example an instant messaging (IM) server in communication with the network receives requests to initiate media-sharing sessions, the requests including the addresses of potential participants. Upon receiving the request, the IM server determines if any of the potential participants are, in fact, connected to the network and, if so, transmits their network address to the requesting entity so that it can begin transmitting the media to each of them. The media is usually played from a recording by one of the participants, but the selection is heard by the group members as it is being transmitted, creating a shared-listening environment. To avoid potential copyright infringement, the media is played but not stored for later play at any of the recipient terminals.

The present invention relates generally to network-based media sharing, and more specifically to a system and method for sharing media, and especially audio media, among peers through a communications network to allow a number of participants to simultaneously enjoy a media presentation despite being located in geographically separated areas.

### BACKGROUND OF THE INVENTION

Sharing a music listening experience, where two or more people simultaneously hear the same music while they are in some way together, is one of many ways in which humans socially interact. Music can be shared by attending live performance together, of course, but also by gathering to play previously recorded music. There are currently many ways in which music can be recorded for playback on an appropriate device, such as a tape, record, or compact disk (CD) player. The music may then be shared by two, or almost any number of listeners, so long as they all are within range of speakers connected to the playback device. In addition, there may be a relatively large number of speakers, each connected to the playing device by wires, or even by a wireless link. As long as listeners are within earshot of any one or them they can still share in the music experience. The speakers may be place at some distance from each other, meaning that any two listeners may be separated by a distance of up to a hundred feet or more.

While greater distances between listeners are possible, they are generally not practicable with such a system. Except in special circumstances, the cost and difficulty of setting up a single playback device to drive multiple speakers that are located ten or a hundred miles apart are not justified by the benefit of being able to listen to a given musical selection at the same time. Multiple listeners could, of course, listen to the same broadcast radio or television program much more easily. They would then give up, however, almost all control over what music was being played at a particular time. Until the widespread availability of the Internet as a communication medium, a group of listeners who wanted to share a music listening experience at a distance were faced with this choice, that is, control over the music selection at a relatively small distance or surrendering control to share a media presentation across a larger distance.

The Internet, in fact, is increasing being used as a medium for many forms of social connectivity. In this, it has not entirely replaced the telephone, where speech can be transmitted almost instantaneously in most cases, thus facilitating normal conversation. When physical co-location is not possible, the telephone provides an intimate, immediate, and satisfactory substitute. The telephone has its limitations, however. There is generally but a single “channel”, and it is virtually limited to voice communications. This means that the opportunities for contemporaneously sharing another type of sensory experience instead of, or at the same time as the telephone conversation are limited. Exceptions do occur, however, such as where the two parties to a telephone call are watching the same television broadcast, perhaps a sporting event. The intimacy of the communication is enhanced because the parties can discuss a shared experience while they are actually sharing it.

Rather than replacing the telephone, Internet communications have altered physically-distant social experiences. The most prominent means of communicating via the Internet, of course, is using electronic mail, commonly known as “email”. In this mode, a correspondent writes a letter of almost any length and transmits it to one or more intended recipients. In most systems, any number of computer files, text or otherwise, may be “attached” to the email and sent along with it. The path taken by the email message will vary depending on how the parties are actually connected to the Internet. Typically, the sender and recipient will both be connected through an Internet Service Provider (ISP) that maintains a mail server in constant connection to the Internet. In this case, the mail message is sent to the sender's ISP and relayed to the recipient's ISP, where it is stored until retrieved, or “downloaded”, when the recipient connects. Email may travel quite quickly even over vast distances, but it is usually not in any sense immediate. On the other hand, a message may be sent even when the recipient is unavailable, and the sender can take as much time as desired in order to thoughtfully compose it. In contrast to a posted letter, however, email is much more rapid, and the therefore immediacy and intimacy of a (voice) telephone connection is not totally lost.

The capacity of both Internet connections, and of the computers and other devices used to make those connections, has increased to the point where recorded audio files may be transmitted from one user to another. This may be accomplished, for example, simply by sending an audio file as an attachment to an email. This provides for a new form of music sharing, although not an altogether satisfactory one. The effort necessary to coordinate simultaneous play once the file has been delivered makes this method little better than if each listener simply acquired the selection in recorded form for themselves. Some cost savings would be realized, of course, but this presents a separate issue. Because the listeners are actually engaged in the unauthorized reproduction and distribution of recorded music, they may run afoul of copyright laws. Rather than simply listening to a recording together, the group is creating multiple copies in a way that it typically prohibited.

Another way to share a listening experience is to use one of the several available media-sharing services, for example Napster®, which have provided servers and storage devices, accessible through the Internet. Accessing these servers by going to the respective Web site, multiple listeners may download an audio file stored on the server by another listener. In other words, these services provide a convenient way to transmit music files from one person to a large number of others. While the distribution process is somewhat simplified using such a service, which does represent an improvement over the use of email attachments, violation of copyright law is still a possibility. And as with simply having each user in a defined group purchase the musical selection for themselves, arranging a simultaneous-listening session to create a shared music environment remains a cumbersome procedure.

Needed, then, is a way to efficiently and easily create a shared-media environment so that two or more listeners separated by a distance may have the same listening experience at the same time, while not infringing on the copyrights of the music owners. The system and method of the present invention provides one such solution.

### SUMMARY OF THE INVENTION

The present invention is directed to providing a way for multiple listeners connected to a common network to simultaneously to a selection chosen and played by one of them. In one aspect, the present invention is a method for peer-to peer media sharing, including the steps of providing a messaging server in communication with the network, receiving a request in the server to begin a media-sharing session involving other participants, determining whether the other participants listed in the request are in communication with the network, and, if so, providing the requestor with the network addresses of other group members so that the media selection, when played, may be transmitted directed to them and played at their communications terminals as the time it is received. The method may further include the step of selecting which of a number of participants in the media sharing session will be the originator of the shared media.

In another aspect, the present invention is a system for enabling peer-to-peer media sharing via a communication network. The system includes a server connected to a communication network, the server having a chat room function such that potential participants may enter the chat room and request a media sharing session, and a controller for processing the received requests. The system further includes a database in communication with the server for storing addresses of participants includes a messaging server in communication with the network, wherein the server is capable of determining whether potential group members are also in communication with the network and, if so, providing their address to the requesting terminal so that the media may be transmitted directly to them.

### BRIEF DESCRIPTION OF THE DRAWINGS

For a more complete understanding of the present invention, and the advantages thereof, reference is made to the following drawings in the detailed description below:

FIG. 1 is a simplified block diagram illustrating a communication network such as one that may be used for peer-to-peer media sharing in accordance with an embodiment of the present invention.

FIG. 2 is a simplified block diagram illustrating the flow of shared media according to one embodiment of the present invention.

FIG. 3 is a flow chart illustrating a method of peer-to-peer media sharing according to an embodiment of the present invention.

### DETAILED DESCRIPTION

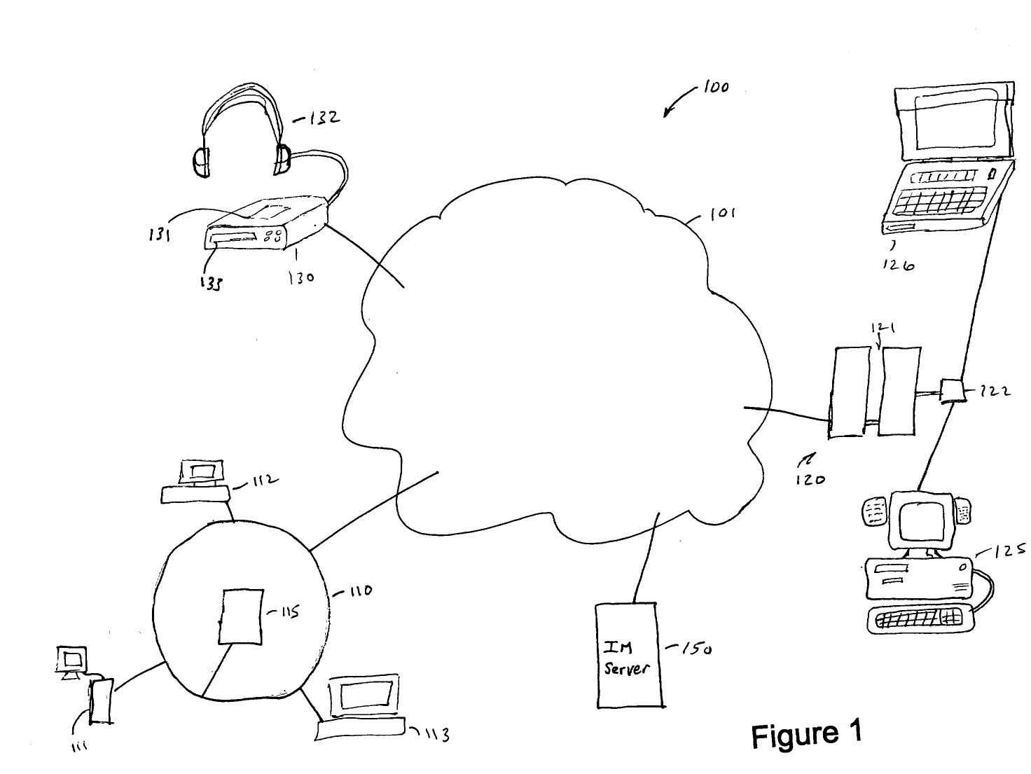

FIGS. 1 through 3, discussed below, and the various embodiments used to describe the present invention are by way of illustration only, and should not be construed to limit the scope of the invention. Those skilled in the art will understand the principles of the present invention may be implemented in a variety of applications in addition to those specifically discussed herein.

FIG. 1 is a simplified block diagram illustrating a communication network 100 such as one that may be used for peer-to-peer media sharing in accordance with an embodiment of the present invention. Note that FIG. 1 is intended to illustrate the number of different configurations that may be used for connecting with a network, such as Internet 101 in order to take advantage of the present invention. Although the intent is to show variety, it is not meant to be in any way an exhaustive listing. Many other combinations are possible. Nor does the “communication network” have to have any specific, or even stable configuration, as long as the interconnection to the various nodes that will share the media are made or capable of being made, and that the network is otherwise configured in order to be able to execute the present invention, as more fully explained below. It is for this reason, of course, that Internet 101 is traditionally shown as a cloud, because it may take any number of configurations and varies almost continuously. Moreover, even though the Internet is an extremely popular, and almost universally available communications network, there will certainly be other networks that will be suitable for the peer-to-peer media sharing according to the present invention.

For example, although it may currently be available in limited circumstances only, a mobile device communicating through a wireless communication network may be used. In this case (not shown), the wireless network would need to be able to transmit the audio being shared on a fairly reliable basis. The mobile instrument may also have a less than satisfactory speaker for playing the audio file, a problem that may be solved by attaching to headphones or some other external device. It should be noted, however, that no particular level of sound or transmission quality is required in accordance with the present invention.

Returning to the embodiment of FIG. 1, it should be apparent that there are numerous ways of connecting with Internet 101. For example, local area network (LAN) 110 is actually a small network used for connecting personal computers 111, 112, and 113, in a token ring configuration. In general, this network may be in place so that users operating each of the PCs may share data, send messages to one another, and utilize common computing resources to which they are connected. Although a direct (wire) connection is implied in FIG. 1, personal computers 111, 112, and 113 may also use a wireless connection to the LAN or to each other. In this regard, short range radio technology such as Bluetooth now enables electrical components to communicate directly with each other. This connection may be exploited in the media sharing experience of the present invention as well.

A connection to Internet 101 is not necessary for the operation of LAN 110, although it is often desirable. Properly configured, each of the PCs 111, 112, and 113 are independently capable of establishing contact with another device through Internet 101, and the user may not even realize that the connection is being made through LAN 110. Another common manner of connecting to the Internet 101 is through an Internet service provider, such as ISP 120. ISP 120 typically includes server or set of servers 121 and a modem 122 for communicating with subscribers of the service. The service an ISP provides is basically that of a permanent connection to the Internet that subscribers may utilize by contacting the ISP through modem 122. In the embodiment of FIG. 1, personal computer 125 and laptop 126 are each connected through some form of connection to the ISP's modem. This is typically a “dial-up” connection through standard public switch telephone network (PSTN), but may also be a direct line, such as a T1 line, or a wireless connection as well. Portable laptop 126 may, for example, wish to connect through the public switched telephone network PSTN (not shown) in order to take advantage of that network's ubiquitous nature. At least in theory, anywhere it is located laptop 126 may establish a telephone connection and communicate through its ISP. The ISP may even have multiple servers that are geographically dispersed (not shown), so as to frequently be accessible through a local telephone number. These dispersed servers themselves may be connected via a dedicated line or through Internet 101. In other words, servers 121 have some way of receiving all subscriber communications and routing them appropriately. Naturally, subscribers may only download information from the servers 121 when a connection has been established.

Any given device may also be connected directly to the Internet. For example, media player 130 maintains a direct connection to Internet 101. Media player 130 has a display 131 for displaying video, text and graphical information obtained through its connection to Internet 101, and headphones 132 for allowing the subscriber to listen to audio. DVD driver 133 is also available in media player 130 for the purpose of either playing multimedia presentation for local consumption or for transmitting it in some form or fashion through Internet 101 to one or more intended recipients.

According to the manner in which Internet 101 functions for a given session, a direct connection is not typically established between any new two communicating nodes. At the point where a particular device is actually connected with Internet 101, any transmissions are broken into packets that are each then separately addressed, and transmitted to the intended recipient. Each packet may take a different route from one node to the number. The recipient node reassembles them in the correct order so that they can be downloaded and, if part of a multimedia file, played. The Internet 101 is constructed in this fashion so that the elimination (temporarily or permanently) of any one, or even several nodes, will not interfere with the transmission of packet data from one node to another. The packets simply take an available route, rather than trying to make their way to the recipient through a failed node. Aside from the advantage of survivability, this also enables the Internet 101 to transmit data through the most efficient and least congested route, and does not dedicate network resources to connections established for an extended duration and dedicated to a particular communication session even when no actual communication is taking place.

Many types of communication may be conducted via the Internet 101. For example, the PC 125, properly connected to the Internet 101 through ISP 120 may request and receive Web pages that are stored on LAN server 115. A Web page is simply a collection of information that may be retrieved in order to display at the requesting terminal text, graphics, and other types of media. Another common type of communication is electronic mail or “email”, where one Internet connected device such as laptop 126 may send a text message or data file to, for example, PC 113 through LAN 110. As the two terminals, 113 and 126, communicate back and forth with each other via email, the messages themselves may be stored on servers 121 or LAN server 115, respectively, until such time as the individual device requests a download of stored email messages.

Another type of communication that has recently seen gains in popularity is the sending of “instant messages”. An instant message, often a text message, is sent from one node that is at the present time connected to Internet 101 to another. Both nodes must be connected to the Internet 101 (or other applicable network) for the message transmission to be ‘instantly’ completed. Instant message server 150, which alternately may be simply a part of ISP 120 but may function independently as shown in FIG. 1, provides the instant messaging service. It determines that both the sending station and the intended recipient are in fact connected to the Internet, determines their Internet addresses (either static or dynamic) and enables the routing of an instant message from one directly to the other. Instant messages are therefore not generally stored on a server such as servers 121 or LAN server 115, but rather pass directly from one Internet connected device to another. The advantage of this technology is speed, with different subscribers being able to communicate with each other at virtually the speed of normal conversation, depending on how quickly they provide input through typing on a keypad, or by some other method.

In accordance with an embodiment of the present invention, subscribers not only send text messages as instant messages, but may also utilize the instant messaging methodology in order to transmit audio media from one to the other. The process for performing this type of communication is described more fully below. In general, a user wishing to share music with one or more others first contacts the IM server to determine if they are on-line (that is, connected to the same network). The IM server 150 responds, either in the negative—in which case no sharing will take place—or in the affirmative. An affirmative response will contain sufficient information for the first user to begin the sharing process. Both (or more, if applicable) then listen to the chosen selection at virtually the same time. More precisely, some delay in transmission is inevitable, but it is not usually significant enough to detract materially from the sharing experience. Note that the instant messaging procedure may be modified to permit the sending of messages to a user that is not on-line by providing the sender with the address of an available storage facility, which will relay the message at a time when the intended recipient's presence in the network environment is registered.

Because of the immediate nature of the instant messaging service, both users may simultaneously listen to a particular audio selection that is being played on a node associated with one of them through their own respective computer (or connected sound) equipment at the same time. This presents several advantages. The first, obviously, is communal. People separated by some geographic distance, or who are otherwise unable to travel to visit with one another, may communicate and share common experiences even though they are not able to actually come together in physically the same physical location. The second is economical, where one person may purchase a particular musical selection, and permit friends and family to listen as well. The peer-to-peer shared media experience is similar to the situation where a person invites a number of friends over to listen together to a newly acquired compact disc (CD). The third advantage has to do with respecting the copyrights of artists and publishing companies. Whereas, in the past it had become popular to send actual copies of audio recordings via the Internet to recipients who could then store and play them, in accordance with the present invention, no actual copy of the music file is being transmitted. Rather each listener in the media-sharing group hears the selection being played at the time it is played, and is preferably not allowed to retain a copy, either electronically or on some other physical storage medium.

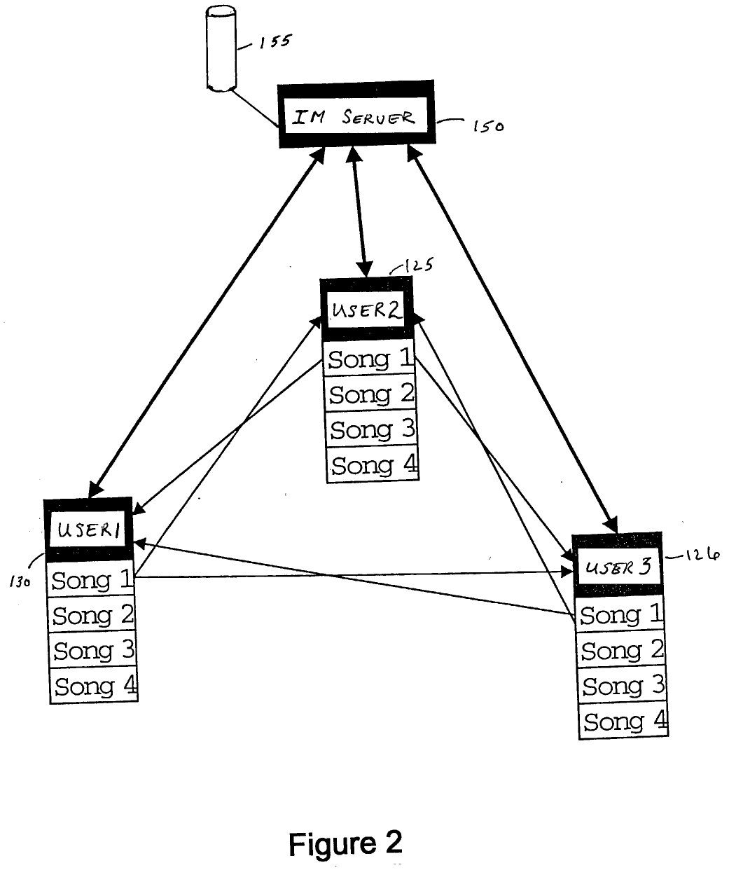

As just one example, in the embodiment of FIG. 1, the user in possession of media player 130 arranges with the users owning PC 125 and laptop 126 in order to listen to a newly acquired CD (or DVD). As the CD is played on media player 130 it is also directed by instant messaging server 150 directly through ISP 120 and then to the users associated with PC 125 and laptop 126, respectively. FIG. 2 illustrates this concept in more detail.

FIG. 2 is a simplified block diagram illustrating the flow of shared media according to one embodiment of the present invention. In this instance, the devices involved are merely shown schematically, User 1 being associated with media player 130, User 2 being associated with PC 125, and User 3 being associated with laptop 126. Note that each is in communication with IM server 150, although the intermediate network connections such as ISP 120 and Internet 101 are not shown for the purpose of clarity. In the embodiment of FIG. 2, however, each is connected in some way through a common communication network, such as Internet 101, a circumstance known to IM server 150. For simplicity, the connection between each of the terminals (user devices) and IM server 150 are illustrated by a bold line having an arrowhead on each end. In this embodiment, User 1 establishes with IM server 150 that User 2 on personal computer 125 and User 3 on laptop 126 are also communicating with IM server 150. In other words, their presence on the network has been registered in IM database 155. IM server 150 may also transmit a general query, if necessary, to determine the availability of particular terminals. Information relating to the availability and addresses of these various terminals may be stored, at least temporarily, in IM database 155 so that repeated querying is not always necessary. IM database 155 may also store information relating to the capabilities of selected (IM-service) subscribers, as may be necessary or desirable for efficient setup of media sharing sessions.

This being accomplished, User 1 loads the appropriate compact disc into media player 130 and proceeds to play the first selection, which has here been labeled song 1. Because User 1 is now in possession of the Internet addresses associated with PC 125 and laptop 126, the audio associated with the song is sent directly to User 2 and User 3 as shown in FIG. 2. In this embodiment, in like fashion, User 2 then plays and transmits a song 1 to users 1 and 3, respectively. Finally, User 3 transmits a song 1 directly to users 1 and 2. In order to do this, of course, users 2 and 3 must each have their respective songs 1 on a tape, compact disc, or other storage device. Each user plays a song for transmission to the others and the established group, but neither of the other users retains, or in a preferred embodiment, is even able to retain, a copy of the transmitted selection. This means that if User 3 is called away during the media-sharing session and unable to listen to a portion of song 1 being transmitted from User 1, that there is no way to go back, retrieve and play again the missed portion of the selection. In this way, it is hoped that laws respecting copyrights of authors and their works are not violated.

The order of play may be determined in any number of ways. In one embodiment, each user indicates the selections that they want to share with the other members of the group and a play list is established. The play list may be generated by any of the users or by the IM server 150. Preferably the list is then transmitted to each of the users in the group. Each user may then display the list, assuming an appropriate display is available to them. A “time-remaining” indicator may be present in association with each listed selection so that the user whose selection is to follow may load the appropriate media ahead of time and avoid delay. In a preferred embodiment, users may request changes to the play list but transmitting an appropriate message to the entity that generated it initially. In an alternate embodiment, users are able to communicate a list of available selections, for example those in a collection of CDs accessible to media player 130, to IM server 150. The list may be sent to other users as well. One user may then request a particular selection and instruct, or cause server 150 to instruct the appropriate device to play it. In addition, the list may include outside sources for particular selections, outside referring to network nodes not currently participating in the media-sharing session. (Such sources may participate in the session for a fee enabling the group members to pay for the privilege of listening to a particular selection, the cost depending on the number of participants in the group).

Membership in the listening group may be dynamic. An intended recipient that was not available at the beginning of the session may become connected; others may leave the group. Preferably, the changes in group membership are stored in database 155 so that revised lists may be communicated to all currently listening members. Note, however, that a separate IM server is not a requirement. If any one or more of the listening entities are capable of performing this function they are of course permitted to do so. Also note that although an “instant messaging” server is recited in this embodiment, other types of servers, for example multimedia messaging servers, may be used as well. In addition it is of course the function of the server that is important and the name or label ascribed to it. In this regard, the server in the embodiment described simply supports the peer-to-peer transmission of media from one user to another. In an alternate embodiment this support may include actually routing the transmissions between users. While this may require a temporary storage of the transmitted media (or sequential portions of it), this is not the same as retaining a copy for downloading by subscribers.

Group members may during the session participate in a chat room in order to discuss or comment on the selection currently being played, or to indicate preferences for future selections. The chat room may interface directly with the process of setting up the media-sharing session, and entering the chat room may even be made a prerequisite for joining the shared-listening experience. Of course, listeners could simply use the telephone or some other media for interpersonal communication as well.

The possibility of simply retaining an unauthorized copy of any received media (for later playback after the group listening session), which may infringe another's copyright, is in some ways inherent in the system and method of the present invention. Steps may be taken, however, to reduce the ease or desirability of doing so. For example, to participate a user will normally have to acquire and install a software package, subscribe to a service, or both. The service or software may simply restrict or not permit potentially undesirable activities. In addition, the media selections shared in this fashion may be delivered to secondary listeners (those not having the original recording) in less than perfect quality.

This imperfection may be natural or by overt operation. Although modem digital recordings are normally of very high quality, the immediate nature of peer-to-peer media sharing may mean that some level of quality may have to be sacrificed to ensure timely delivery of each succeeding portion of the media presentation. The generous time for transmitting a media file over a network such as the Internet, including error-checking and correction instructions, is not available where the media is being played as it is received as opposed to being stored for later play. Note, however, that while quality degradation of this type may be inherent, it is not a requirement of the present invention (unless explicitly recited). Where not inherent, the degradation may nevertheless be allowed or even actively induced in order to discourage piracy. Resourceful pirates, of course, may be able to overcome such overtly-instigated deficiencies, but in general would be able to pirate the selection more easily in others ways, such as simply copying a CD. In other words, while any received electrical media could, in theory, be captured and recorded as well as played, such practice is discouraged in the peer-to-peer media-sharing environment of the present invention.

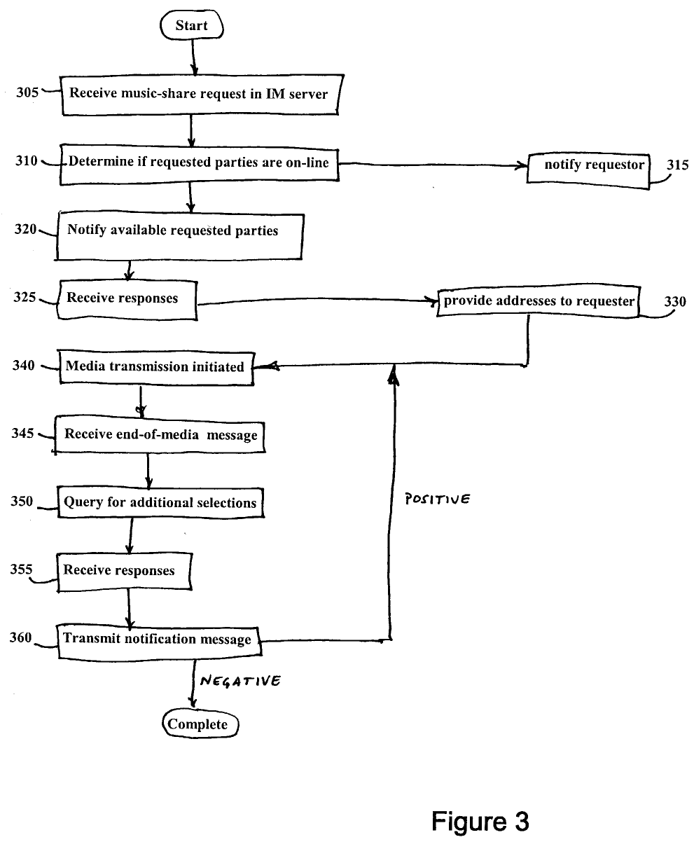

FIG. 3 is a flow chart illustrating a method 300 of peer-to-peer media sharing according to an embodiment of the present invention. At START, it is presumed that in each of the nodes, in this embodiment those represented in FIG. 2 (media player 130, personal computer 125, and laptop 126) have been loaded with appropriate software or subscribed to an equivalent service to enable the peer-to-peer media sharing of the present invention. Again, even though only three nodes are shown, there could be two or any larger number. Before initiating the media sharing process, User 1 generates and transmits an availability request containing the names or addresses of one or more other nodes with which sharing is desired. Note that the process may be started by any one of the nodes generating such a message.

At step 305, IM server 150 receives the query from media player 130 (User 1), who is in fact trying to determine if any of a number (one or more) of other instant messaging subscribers are currently in communication with IM server 150. In this embodiment, this would mean they are connected to the Internet 101. At step 310, IM server 150 determines whether the requested users are in fact connected. This may be done by reference to a database 155, where in this embodiment the IM server 150 stores information about the current status of each of its subscribers. In the case that User 1 wishes to connect with a user who is not a subscriber to instant messaging server 150, the server may have to request additional contact information from media player 130 (step not shown). Preferably, however, the IM server 150 simply uses the identifying information supplied in the user query in order to find the different subscribers. If it is not noted in database 155 that a particular terminal is currently in active communication with IM server 150, then an email, or some other form of message may be sent in order to make this determination (step not shown). Once the determination is made, of course, the status information may be stored in database 155 (step also not shown).

The IM server 150 then transmits to User 1 an appropriate message indicating whether any of the requested users are available (step 315). For users that are determined to be available, the IM server 150 also transmits a message to each of them (step 320) informing them that User 1 using media player 130 wishes to initiate a media-sharing communication session. In a preferred embodiment, IM server 150 then waits for a predetermined amount of time to receive an acknowledgment from any or all of the connected users (step 325). After the passage of this predetermined time, IM server 150 transmits to media player 130 a list of those users connected to Internet 101 that wish to participate in the media session (step 330). Within this message returned to media server 130, IM server 150 includes the Internet (or other network) addresses associated with each of the available (and willing) users. User 1 using media player 130 and the appropriate media-sharing software (or service) initiates transmission of the media (step 340), which is then transmitted directly to the Internet address associated with each available user.

The peer-to-peer media sharing session may end in any of a variety of ways. In the embodiment of FIG. 3, User 1 simply stops playing the selection and media player 130 generates and transmits an appropriate message to IM server 150. When IM server receives such a message (step 345), it transmits to the member of the share group a query (step 350) to determine if there are any additional selections to be shared. This query could be sent first to User 1 and then to the other users, or could be sent to all at once. When a response to this query is received (step 355), IM server 150 generates an appropriate notification message and sends it to group members (step 360). Note that such a message may be generated upon receiving the first affirmative response, in which case the method 300 returns to step 340. Negative responses may simply be noted (step not shown) until all group members have responded in that fashion, in which case the message sent at step 360 will indicate the session is complete. Alternately, all users may be notified when each negative response is received, perhaps to inform their own decision regarding whether to participate.

Alternate methods (not shown) of terminating the session are also possible. For example, User 1 may have indicated in advance that only a particular musical selection would be transmitted, or simply indicated the amount of time the transmission session should last. There may also be a time limit associated with the particular instant messaging service provider or the software itself. In a particularly preferred embodiment, the session will last for a predetermined amount of time, for example, 20 minutes, at which time the software on media player 130 (either with or without interrupting the transmission itself) displays a query asking User 1 whether to continue transmission is desirable. Again, the answer to such a query will be acted upon, with no response from User 1 being taken as a default response, again either to continue or not to continue. As mentioned above, a play list may be used as well.

If at any time IM server 150 receives an indication that a particular communication terminal specified in the query it received at step 305 is now available, it will transmit to media station 130 a message indicating that fact. At that time, User 1 will indicate in response whether it wishes to include this particular user, and if so, simply utilizes the address received from IM server 150 in order to send to it directly the shared media content. In this regard, it is also noted that the group will frequently not remain static, with some users joining and others departing at their own discretion. Generally speaking, however, the group is not open to all potential listeners, but only to those that the existing group members have indicated (collectively or independently, depending on the particular application.) It may be desirable, however, to allow an invited listener to invite others as well. The group size, of course, may be limited, and the amount of time any one user may participate may be limited as well.

Whatever the specific rules of participation, the system and method of the present invention enable two or more geographically-separated users to enjoy the same musical selection at the same time, just as they could if they were all gathered at the same location. It should be noted, however, that there is no requirement of distance. While the advantage of the system and method of the present invention inhere to listeners who are far apart, it may be used for those who are not, for example students in adjacent dorm rooms. Email, text-messaging, or even voice-over IP (VoIP) communications may be allowed between or during the transmission of media selections so that the group members may exchange comments. Pictures of each locale may even be exchanged so that each listener may visualize the others in the group, or a simulated group picture may be generated.

Not all of the listeners in the group need to be using the peer-to-peer media sharing technique described above. In other words, a group may contain users that are in close enough proximity that they can use a short-range wireless connection to share between them (whether either of them are originating the transmission). In one embodiment of the invention (not shown) each entity in the sharing group is able to ascertain what communication conduits are available to support their participation in the media-sharing session and to utilize the path that is most efficient. This choice may of course be altered from time to time during the session, if appropriate. In another embodiment, this determination is made by server 150, which then proceeds to notify one or more user nodes that another form of communication may be more appropriate.

Finally, note that the descriptions above are of preferred examples for implementing the invention, and the scope of the invention should not necessarily be limited by this description. The scope of the present invention is defined by the following claims.

What is claimed is:

1. A method for peer-to-peer media sharing via a network such as the Internet, said method comprising the steps of:
providing a messaging server in communication with the network;
receiving in the server a request to initiate a peer-to-peer media-sharing session including at least two entities as participants;
confirming that the at least two entities are in communication with the network;
determining the network address of each participant;
determining which of the participants will be the first media source; and
transmitting to the media sources the network addresses of each other participant to enable the media to be sent to them directly.

2. The method of claim 1, wherein the server receives a plurality of initiation requests and further comprising the steps of:
storing received requests in a queue; and
selecting a first source.

3. The method of claim 2, wherein the step of selecting is performed according to a random selection process.

4. The method of claim 2, wherein the step of selecting is performed by selecting the requests in the order that they are received at the server.

5. The method of claim 4, wherein the server includes a clock for timing the duration of time that media content has been transmitted from the first media source.

6. The method of claim 5, further including the step of terminating the media transmission from the first media source and enabling media transmission from a second media source.

7. The method of claim 1, wherein the server is a participant in the media-sharing session.

8. The method of claim 1, wherein the media-sharing request includes the address of a media source, and further comprising the step of transmitting a query to the media source to determine if the media source will participate in the media-sharing session.

9. The method of claim 1, wherein the message sever is in communication with a database populated with a list of media sources, 'and further comprising the step of selecting a source from the list of media sources.

10. The method of claim 9, wherein selection of a media source is based upon a previously received request.

11. An system for peer-to-peer media sharing via a communication network such as the Internet, said system comprising:
a server in communication with the network, the server comprising:
a chat-room function for supporting a chat room accessible through the network, and through which media-sharing requests may be received; and
a controller for processing received requests by determining network addresses for each intended participant; and
a database for storing the addresses associated with media-sharing participants; wherein the sever enables the transmission of shared media by providing an originating participant with the addresses of the other participants.

12. The system of claim 11, wherein all of the chat room participants are selected to receive the transmitted media.

13. The system of claim 11, wherein the chat room participants selected to receive the transmitted media are those that respond positively to a query from the server.

14. The server of claim 11, further comprising a database in communication with the server for storing a participant-capability file including information related to the media-receiving capabilities of each participant.

15. The server of claim 14, wherein the chat room participants selected to receive media are those capable of receiving it, according to the information stored in the participant-capability file.

16. The server of claim 11, wherein the database also contains a media source file for maintaining the network addresses of media sources.

17. The server of claim 11 wherein the database also contains a menu file for storing information that may be transmitted to a participant to generate a menu of media choices for the participant to select from.
